(19) United States
(12) Patent Application Publication
(10) Pub. No.: US 2005/0278424 A1
(43) Pub. Date: Dec. 15, 2005

(54) Network conferencing using method for concurrent real time broadcast and distributed computing and/or distributed objects

(76) Inventor: Wesley White, Kennesaw, GA (US)

Correspondence Address: BAMBI FAIVRE WALTERS, PO BOX 5743, WILLIAMSBURG, VA, 23188, US

(21) Appl. No.: 10/854,055

(22) Filed: May 26, 2004

(51) Int. Cl. G06F 15/16

(52) U.S. Cl. 709/204

(57) ABSTRACT

Prior to the conference, a Concurrent Real Time and Distributed Computing/Objects Conferencing Module communicates a library of digital objects to at least one participant communications device via a distributed computing and/or distributed objects network. During the conference, the host communicates a synchronization command to the at least one participant communications device, and the synchronization command instructs the participant communications device to present a synchronized object. Then, a non-participant communicates with the host to join the conference, and in response, the host communicates a real-time object to the add-in participant communications device. Concurrently, the host analyzes a conference communications factor to determine a subsequent conference communications connection that leverages distributed computing and/or distributed objects of the conference network. Thereafter, the subsequent communications connection is established. Furthermore, the add-in participant communications device and participant communications device may communicate a synchronization acknowledgment back to the Concurrent Real Time and Distributed Computing/Objects Conferencing Module. The synchronization confirmation acknowledges a successful presentation of the synchronized object to the add-in participant and/or participant communications device.

### CROSS REFERENCE TO RELATED APPLICATIONS

This application relates to applicant's co-pending application entitled “Methods, Systems, and Products for Network Conferencing,” (Attorney Docket BS030557) filed Apr. 23, 2004, and of which the “Brief Summary of the Invention” and “Detailed Description of the Invention” sections are incorporated herein by this reference.

This application relates to applicant's co-pending application entitled “Network Conference Using Method For Distributed Computing And/Or Distributed Objects,” (Attorney Docket BS040098) filed simultaneously herewith and of which the “Brief Summary of the Invention” and “Detailed Description of the Invention” sections are incorporated herein by this reference.

This application relates to applicant's co-pending application entitled “Network Conferencing Using Method For Distributed Computing And/Or Distributed Objects To Intermediate Host For Presentation To a Communications Device,” (Attorney Docket BS040139) filed simultaneously herewith and of which the “Brief Summary of the Invention” and “Detailed Description of the Invention” sections are incorporated herein by this reference.

This application relates to applicant's co-pending application entitled “Network Conferencing Using Method For Distributed Computing And/Or Distributed Objects For Presentation To A Mobile Communications Device,” (Attorney Docket BS040191) filed simultaneously herewith and of which the “Brief Summary of the Invention” and “Detailed Description of the Invention” sections are incorporated herein by this reference.

This application relates to applicant's co-pending application entitled “Methods, Systems, and Products for Network Conferencing,” (Attorney Docket BS040192) filed simultaneously herewith and of which the “Brief Summary of the Invention” and “Detailed Description of the Invention” sections are incorporated herein by this reference.

### NOTICE OF COPYRIGHT PROTECTION

A portion of the disclosure of this patent document and its figures contain material subject to copyright protection. The copyright owner has no objection to the facsimile reproduction by anyone of the patent document or the patent disclosure, but otherwise reserves all copyrights whatsoever.

### BACKGROUND OF THE INVENTION

1. Field of the Invention

This invention generally relates to conferencing over telecommunications and/or data networks and, more particularly, to concurrent real-time communications and distributed data transfer for synchronized conferencing.

2. Description of the Related Art

Bandwidth is a problem when conferencing. Video and/or desktop conferencing, such as training sessions and other distributed presentations, often requires real-time streaming of the presentation materials. If the remote participants are few in number, and if the file size of the presentation materials is manageable, then real-time data streaming may provide an adequate quality of presentation. If, however, there are a large number of remote participants or the file size of the materials is quite large, then real-time streaming poses problems. As the number of remote participants increases and/or as the file size of the presentation materials increases, the required bandwidth also increases. Fifty (50) remote participants, for example, require fifty (50) real-time data streams fanning out from the host computer. As the number of remote participants increases, the host computer is also taxed to manage communications with all the remote computers. All the participants to the conference, then, eventually suffer from network congestion and from degradation in processor performance. The quality of the conference is reduced, and all the participants to the conference have a less-than-desirable experience. There is, accordingly, a need in the art for methods, systems, and products for improved conferencing among remote participants. There is also a need for reducing the bandwidth required when conferencing that does not rely upon real-time streaming.

### BRIEF SUMMARY OF THE INVENTION

The aforementioned problems, and other problems, are reduced by this invention. This invention comprises methods, computer systems, computer programs, and computer program products that improve conferencing among remote participants. This invention also leverages conference communications assets to add in a new participant with concurrent real-time communications and distributed computing and/or distributed objects. This invention does not require real-time streaming of entire presentation materials to all participants, so less bandwidth is required. This invention also includes features that help ensure all participants are synchronized to the host's presentation. As the conference host progresses through a synchronized presentation that leverages distributed computing and/or distributed objects to conference participants, this invention identifies an add-in communication from a non-participant (also referred to as an “add-in participant”) to add in to the conference, communicates a real-time synchronized object of the presentation, analyzes communications connections of participants and of the add-in participant to determine an optimal subsequent conference communications connection with the non-participant, and establishes the subsequent conference communications connection with the add-in participant. Thereafter, the add-in participant as well as other participants may be monitored by the host to identify which participants have viewed a current object (also referred to as the “synchronized object”) of the presentation as well as which participants are lagging behind and/or jumping ahead in the presentation materials. This invention can even include additional conference management features to manage the conference with the add-in participant. For example, the host (and/or a selected participant) can execute commands and/or instructions that enable the add-in participant to exit the conference, delay presentment of the conference, provide unrestricted access of the entire presentation, provide authority to distribute presentation materials to another non-participant of the conference, allow modifications to the presentation, modify a communications connection with the add-in participant, and/or other features. This invention, then, allows the host (and/or the selected participant) to synchronize and control presentation materials to the add-in participant and to provide conference management commands and/or instructions to the add-in participant. Thus, the host is able to more quickly communicate the real-time synchronized object as well as establish a distributed computing and/or distributed object conference session with the add-in participant to minimize and/or prevent real-time streaming of presentation materials. In addition, this invention enables the host (and/or the selected participant) to provide conference management commands, receive communications about the add-in participant's participation, respond to requests, and/or provide subsequent synchronized presentation materials. And, thereby, the host (and/or the selected participant) is able to leverage communication assets among the distributed computing and/or distributed object conference network. Consequently, the host (and/or the selected participant) can tailor the conference to better suit the participant(s) and the add-in participant.

This invention discloses methods, systems, and products for conducting a synchronized conference amongst a concurrent real-time and distributed computing and/or distributed objects communications network (hereinafter referred to as the “concurrent real-time and distributed computing/objects conferencing network”). One of the embodiments describes a method for synchronizing presentation objects to at least one participant communications device and to an add-in participant communications device. Participants may include a participant communications device, an upstream communications device, an intermediate host communications device, and/or a downstream participant communications device. Initially, at least one conference participant is determined and a library of digital objects is communicated to the participant communications device prior to the conference. During the conference, a synchronization command is communicated from the host communications device and/or the server device to the participant communications device to present the synchronized object from the library of digital objects. The synchronization command instructs the participant communications device to present a selected object so that the participant can view, hear, or otherwise be presented the synchronized object and “follow” along with the host during the presentation. Then, the host (and/or the participant communications device) receives an add-in communication from a non-participant communications device to join the conference. In response to the add-in communication, the host (and/or the selected participant communications device) may authorize the non-participant to join, and then communicate a real-time object with the presentation instructions to the add-in participant communications device. The real-time object includes the synchronized object(s) currently being presented to the participant communications devices. Thereafter, the host (and/or the selected participant communications device), analyzes a conference communications factor between the participant communications device and the add-in participant communications device and between the host communications device and each of the participant communications devices and of the add-in participant communications device to determine a subsequent conference communications connection with the add-in participant communications device, and establishes the subsequent conference communications connection. A synchronization acknowledgment may also be communicated to the host communications device (and/or the selected participant communications device). The synchronization acknowledgment identifies the participant communications device and/or the add-in participant communications device and confirms a successful presentation of the object to the participant communications devices and/or the add-in participant communications device.

Other embodiments of this invention describe a system for conducting and/or managing a conference amongst an intermediate host and downstream participants. The system comprises a Concurrent Real Time and Distributed Computing/Objects Conferencing Module stored in a memory device, and a processor communicating with the memory device. According to some of the embodiments of this invention, the Concurrent Real Time and Distributed Computing/Objects Conferencing Module may be stored in a memory device of a host communications device and/or a server having the presentation materials. Alternatively, the Concurrent Real Time and Distributed Computing/Objects Conferencing Module may be stored in a selected participant communications device, such as an intermediate host communications device. Prior to the conference, the Concurrent Real Time and Distributed Computing/Objects Conferencing Module initializes the conference for at least one participant communications device and communicates a library of digital objects to the participant communications device. During the conference, the Concurrent Real Time and Distributed Computing/Objects Conferencing Module communicates a synchronization command to the participant communications device, and in response to the synchronization command, the participant communications device presents an object from the library of digital objects, such that the participant communications device “follows along” with the synchronized object selected by the host communications device. Then, during the conference, the Concurrent Real Time and Distributed Computing/Objects Conferencing Module receives an add-in communication from a non-participant communications device to add in to the conference. In response to this communication, the Concurrent Real Time and Distributed Computing/Objects Conferencing Module communicates a real-time object with presentation instructions to the add-in participant communications device such that the add-in participant has near real-time access to the synchronized object of the ongoing presentation. The real-time object is communicated to the add-in participant communications device via a communications network, such as, for example, a telecommunications network (e.g., Public Switched Telephone Network (PSTN)), a data communications network (e.g., an Internet Protocol (IP) communications network), and/or a satellite network. Further, the Concurrent Real Time and Distributed Computing/Objects Conferencing Module analyzes a conference communications factor between the participant communications device and the add-in participant communications device and between the host communications device and each participant communications device and of the add-in participant communications device to determine a subsequent conference communications connection with the add-in participant communications device. For example, the Concurrent Real Time and Distributed Computing/Objects Conferencing Module may compare transmission rates between the host communications device and the add-in participant communications device with transmission rates between the participant communications device and the add-in participant communications device to determine which communications connections to the add-in participant communications device is quicker, and thereby, select the quicker communications connection for subsequent conference communications with the add-in participant communications device. After the subsequent conference communications connection is selected, then the Concurrent Real Time and Distributed Computing/Objects Conferencing Module establishes the subsequent conference communications connection with the add-in participant communications device. After the synchronized object is presented to the add-in participant communications device and/or the participant communications device, a synchronization acknowledgment is communicated via the communications network to the host, and the synchronization acknowledgment confirms a successful (or, alternatively, unsuccessful) presentation of the object on the participant communications devices and/or the add-in participant communications device.

Other embodiments of this invention describe a computer program product. A computer-readable medium stores a Concurrent Real Time and Distributed Computing/Objects Conferencing Module. According to some of the embodiments of this invention, the Concurrent Real Time and Distributed Computing/Objects Conferencing Module may be stored in a memory device of a host communications device and/or a server having the presentation materials. Alternatively, the Concurrent Real Time and Distributed Computing/Objects Conferencing Module may be stored in a selected participant communications device, such as an intermediate host communications device. Prior to the conference, the Concurrent Real Time and Distributed Computing/Objects Conferencing Module initializes the conference for at least one participant communications device and communicates a library of digital objects to the participant communications device. During the conference, the Concurrent Real Time and Distributed Computing/Objects Conferencing Module communicates a synchronization command to the participant communications device, and in response to the synchronization command, the participant communications device presents an object from the library of digital objects, such that the participant communications device “follows along” with the synchronized object selected by the host communications device. Then, during the conference, the Concurrent Real Time and Distributed Computing/Objects Conferencing Module receives an add-in communication from a non-participant communications device to add in to the conference. In response to this communication, the Concurrent Real Time and Distributed Computing/Objects Conferencing Module communicates a real-time object with presentation instructions to the add-in participant communications device such that the add-in participant has near real-time access to the synchronized object of the ongoing presentation. The real-time object is communicated to the add-in participant communications device via a communications network, such as, for example, a telecommunications network (e.g., Public Switched Telephone Network (PSTN)), a data communications network (e.g., an Internet Protocol (IP) communications network), and/or a satellite network. Further, the Concurrent Real Time and Distributed Computing/Objects Conferencing Module analyzes a conference communications factor between the participant communications device and the add-in participant communications device and between the host communications device and each participant communications device and of the add-in participant communications device to determine a subsequent conference communications connection with the add-in participant communications device. For example, the Concurrent Real Time and Distributed Computing/Objects Conferencing Module may compare transmission rates between the host communications device and the add-in participant communications device with transmission rates between the participant communications device and the add-in participant communications device to determine which communications connections to the add-in participant communications device is quicker, and thereby, select the quicker communications connection for subsequent conference communications with the add-in participant communications device. After the subsequent conference communications connection is selected, then the Concurrent Real Time and Distributed Computing/Objects Conferencing Module establishes the subsequent conference communications connection with the add-in participant communications device. After the synchronized object is presented to the add-in participant communications device and/or the participant communications device, a synchronization acknowledgment is communicated via the communications network to the host, and the synchronization acknowledgment confirms a successful (or, alternatively, unsuccessful) presentation of the object on the participant communications devices and/or the add-in participant communications device.

Other systems, methods, and/or computer program products according to embodiments will be or become apparent to one with skill in the art upon review of the following drawings and detailed description. It is intended that all such additional systems, methods, and/or computer program products be included within this description, be within the scope of this invention, and be protected by the accompanying claims.

### BRIEF DESCRIPTION OF THE SEVERAL VIEWS OF THE DRAWINGS

These and other features, aspects, and advantages of the embodiments of this invention are better understood when the following Detailed Description of the Invention is read with reference to the accompanying drawings, wherein:

FIGS. 1-4 are schematics illustrating a concurrent real-time and distributed computing/objects conferencing network for conferencing, synchronization, and management according to some of the exemplary embodiments of this invention;

FIGS. 5-8 are schematics illustrating other concurrent real-time and distributed computing/objects conferencing networks for conferencing, synchronization, and management according to some of the exemplary embodiments of this invention;

FIG. 9 illustrates a block diagram of an operating system according to some of the exemplary embodiments of this invention;

FIGS. 10-11 are schematics depicting another concurrent real-time and distributed computing/objects conferencing network for conferencing, synchronization, and management according to some of the exemplary embodiments of this invention;

FIG. 12 illustrates another block diagram of an operating system according to some of the exemplary embodiments of this invention;

FIGS. 13-14 are schematics depicting still further concurrent real-time and distributed computing/objects conferencing networks for conferencing, synchronization, and management according to some of the exemplary embodiments of this invention; and

FIG. 15 is a flowchart illustrating a concurrent real-time and distributed computing/objects conferencing, synchronization, and management method according to some of the exemplary embodiments of this invention.

### DETAILED DESCRIPTION OF THE INVENTION

This invention now will be described more fully hereinafter with reference to the accompanying drawings, in which exemplary embodiments are shown. This invention may, however, be embodied in many different forms and should not be construed as limited to the embodiments set forth herein. These embodiments are provided so that this disclosure will be thorough and complete and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named manufacturer.

This invention improves conferencing among remote participants and an add-in participant. This invention does not require real-time streaming of entire presentation materials to conference participants, so less bandwidth is required. According to some of the embodiments, the presentation materials are communicated to one or more participant communications devices prior to the conference. During the conference, the participants leverage a distributed computing and/or distributed object network to synchronize presentations of a selected object from a library of digital objects (also referred to as the “synchronized object” and the “current object”). Then, a non-participant requests and/or logs in to join the conference. The host (and/or a selected participant communications device, such as, an intermediate host communications device) may verify and/or otherwise authorize the non-participant to join the conference, and thereafter, communicate a real-time object of the conference. The real-time object is the synchronized object currently being presented to the participant communications devices. In addition, the host communications device (and/or the selected participant communications device) also analyzes communications connections of participants and of the add-in participant to determine an optimal subsequent conference communications connection with the non-participant, and then establishes the subsequent conference communications connection with the add-in participant. This invention includes further features that help ensure that the participants and the add-in participant are synchronized to the host's presentation. As the conference host progresses through the presentation, this invention identifies to the host (and/or the selected participant communications device) which participants and the add-in participant have been presented the synchronized object as well as which of the participants and/or the add-in participant are lagging behind and/or jumping ahead in the presentation materials. This invention can even prevent the host (or other selected participant communications device) from advancing in the presentation materials until all participants and the add-in participant have viewed/heard/loaded the current object of the presentation. This invention can even include additional conference management features to manage the conference with the add-in participant. For example, the host (and/or a selected participant) can execute commands and/or instructions that enable the add-in participant to exit the conference, delay presentment of the conference, provide unrestricted access of the entire presentation, provide authority to distribute presentation materials to another non-participant of the conference, allow modifications to the presentation, modify a communications connection with the add-in participant, and/or other features. This invention, then, allows the host (and/or the selected participant) to synchronize and control presentation materials to the add-in participant and to provide conference management commands and/or instructions to the add-in participant via a concurrent real-time and distributed computing and/or distributed objects communications network (hereinafter referred to as the “concurrent real-time and distributed computing/objects conferencing network”), and, thereby the host can tailor the conference to better suit the add-in participant and the participant(s).

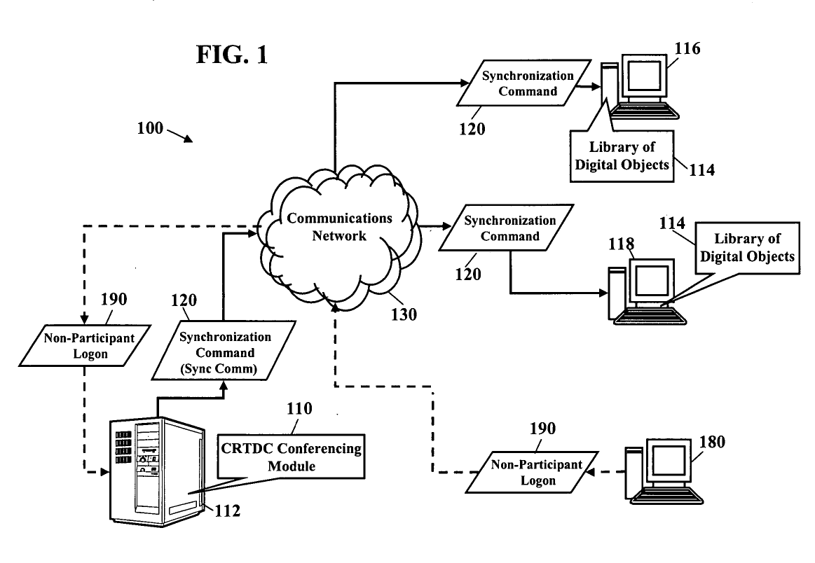

FIG. 1 is a schematic of a concurrent real-time and distributed computing/objects conferencing network 100 illustrating some of the embodiments this invention. A host-resident Concurrent Real Time and Distributed Computing/Objects Conferencing (referred to as “CRTDC Module” in the figures) Module 110 initially manages the conferencing session with participant communications devices 116, 118. Although the Concurrent Real Time and Distributed Computing/Objects Conferencing Module 110 operates within any communications device, FIG. 1 shows the Concurrent Real Time and Distributed Computing/Objects Conferencing Module 110 operating within a host communications device (shown as a server 112). Prior to a scheduled date and time for the conference, a library 114 of digital objects is communicated to the participant communications devices 116, 118. According to embodiments of this invention, the library 114 of digital objects may be communicated from the server 112 to the participant communications devices 116, 118 via a communications network 130, such as, for example, a telecommunications network (e.g., Public Switched Telephone Network (PSTN), Mobile Switching Telephone Office (MSTO), and others), a data network (e.g., an Internet (sometimes alternatively known as the “World Wide Web”), an intranet, a local-area network (LAN), and/or a wide-area network (WAN)), and/or a satellite network. Alternatively, the library 114 of digital objects may be communicated/distributed via physical media, such as a CDROM, memory card, disk, and/or other memory storage device according to other embodiments of this invention. The library 114 of digital objects can be any audible and/or visual presentation materials. The library 114 of digital objects, for example, may include slides (such as MICROSOFT® POWERPOINT® file(s)), pictures, documents, audio, video, and/or any other computer file that can be stored on and/or presented to the participants communications devices 116, 118 (MICROSOFT® and POWERPOINT® are registered trademarks of Microsoft Corporation, One Microsoft Way, Redmond Wash. 98052-6399, (425) 882-8080).

This invention reduces bandwidth requirements. This invention sends the presentation materials ahead of the scheduled date and time of the conference to the conference participant communications devices, and thus eliminates the often cumbersome real-time distribution of presentation materials. Each participant communications devices 116, 118 locally stores the presentation materials. High bandwidth, therefore, is not required by the participant communication devices 116, 118 to participate in the conference.

This invention leverages the communication assets of the concurrent real-time and distributed computing/objects conferencing network 100 including communications paths between and/or among the host/server and participant communications devices and between and/or among each of the participant communications device. Prior to communicating the library 114 of digital objects, the host computer (e.g., server 112 of FIG. 1) transmits an initialization command to identify communication connections, if any, between participant communications devices (e.g., participant communications devices 116, 118 of FIG. 1) and to analyze transmission rates and/or other communications factors between the connected participant communications device(s) and between the host communications device and each of the participant communications device(s) to determine a distributed computing and/or distributed objects conferencing network. One example of the initialization command is the “PING” command in the “Internet Control Message Protocol” (or “ICMP”) protocol (an extension to the Internet Protocol (IP)) to test an Internet connection. For example, applicant's co-pending application entitled “Methods, Systems, and Products for Network Conferencing” (Attorney Docket BS030557) discloses a distributed computing and distributed objects conference network that connects each participant communications device with a host communications device to synchronize and otherwise manage a conference session. Applicant's co-pending application entitled “Network Conference Using Method For Distributed Computing And Distributed Objects,” (Attorney Docket BS040098) further discloses a distributed computing and distributed objects conference network that leverages peer to peer communications connections of an upstream participant communications device and a downstream participant communications device to synchronize and otherwise managed a peer to peer conference session. And, applicant's co-pending application entitled “Network Conferencing Using Method For Distributed Computing And Distributed Objects To Intermediate Host For Presentation To a Communications Device,” (Attorney Docket 04-BS028/BS040139) discloses a distributed computing and distributed objects conference network that leverages intermediate host communications connections of an intermediate host communications device with a downstream participant communications device. Still another example of a distributed computing and/or distributed objects conferencing network is disclosed in applicant's co-pending application entitled “Mobile Network Conferencing,” (Attorney Docket BS040191) that discloses a distributed computing and/or distributed objects conferencing network for mobile participant communications devices.

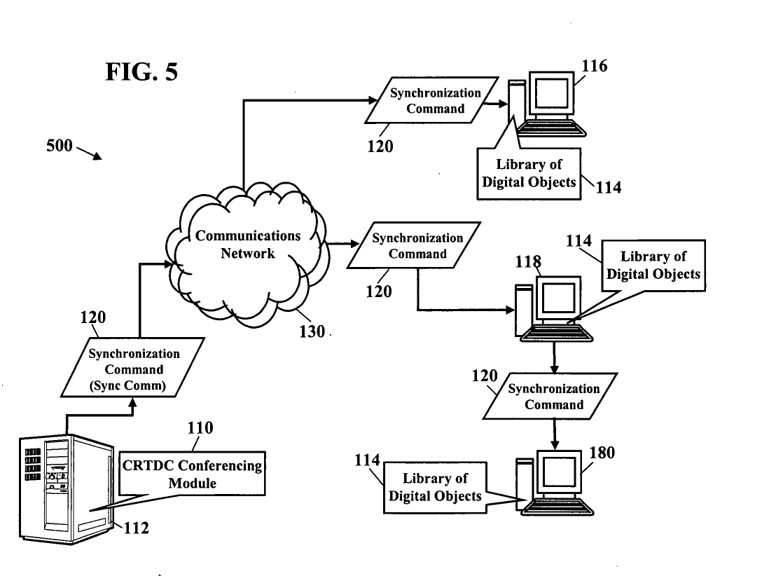

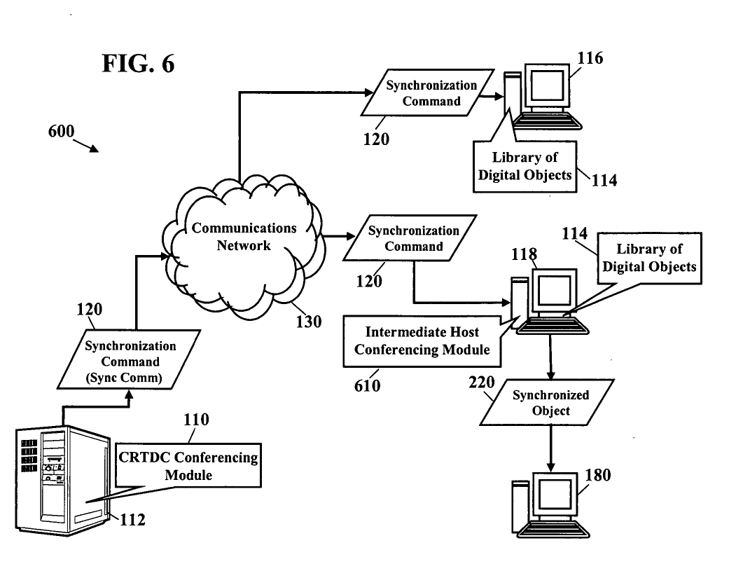

After the distributed computing and/or distributed objects conferencing network is initialized, the library 114 of digital objects is communicated to the selected participant communications device(s) (e.g., reference numerals 116 and 118 of FIG. 1), such as, an upstream participant communications devices (e.g., reference numeral 118 of FIG. 5) or an intermediate host communications device (e.g., reference numeral 118 of FIG. 6). During the conference, a synchronized command 120 is communicated to the selected participant communications device which instructs the selected participant communications device to visually and/or audibly present (e.g., the presentation instructions) a synchronized object from the library 114 of digital objects. According to some embodiments of this invention, the synchronized command 120 may also instruct the selected participant communications device to communicate either the synchronized command 120 or the synchronized object with presentation instructions within the distributed computing/objects conferencing network. The synchronized command 120 instructs the host communications device (or an intermediate host communications device) to switch from one synchronized object 220 to another synchronized object in the library 114 of digital objects, each of the participant communications device “follow along” and synchronize with the host (or with the inter host communications device).

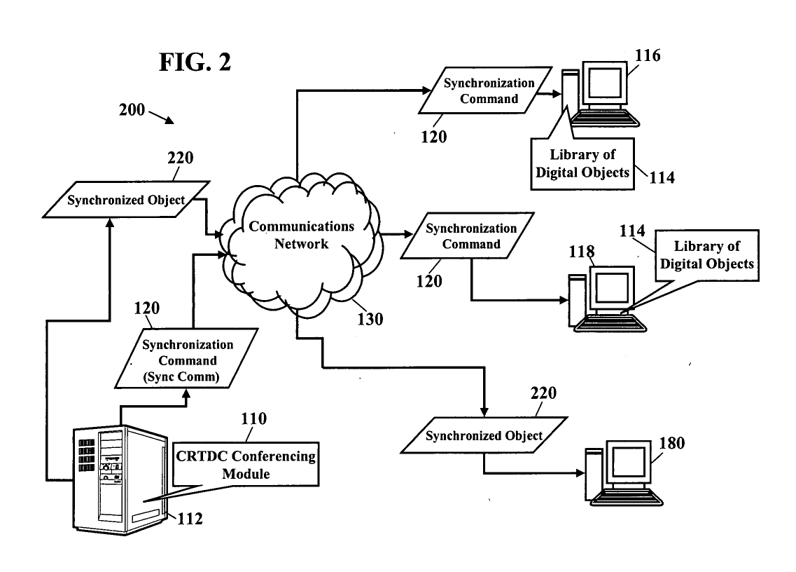

Then, a non-participant communications device 180 communicates a non-participant logon (and/or a request) 190 to the host communications device 112 (or, alternatively, to a participant communications device). The host communications device 112 may verify or otherwise authorize the non-participant to join in the conference as an add-in participant, and then begin to establish a concurrent real-time and distributed computing and/or distributed objects conferencing network (e.g., reference numerals 200, 300, 400, 500, 600, 800, 1000, 1100, 1300, and 1400 of FIGS. 2-8, 10-11, and 13-14). As shown in FIG. 2, the server communicates a real-time synchronized object 220 to the add-in participant communications device 180 during the in progress conference session. The real-time synchronized object 220 is the same synchronized object that is being presented to the participant communications device(s) such that the add-in participant “catches up” and “follows along” with the presentation material(s) selected by the host. Thereafter, the host communications device (and/or a selected participant communications device) analyzes a conference communications factor (e.g., transmission rates, reliability, security, cost, and so on) between the participant communications devices and the add-in participant communications device and between the host communications device and each of the participant communications devices and of the add-in participant communications device to determine a subsequent conference communications connection with the add-in participant communications device.

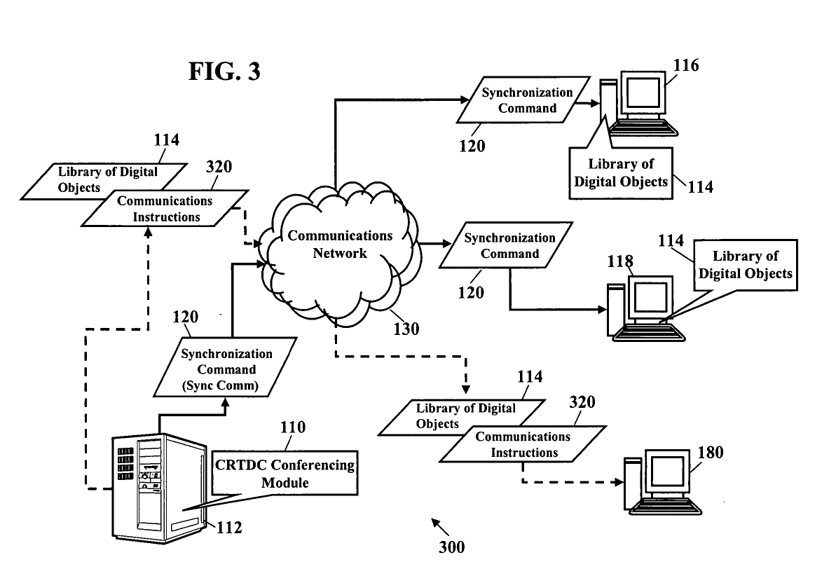

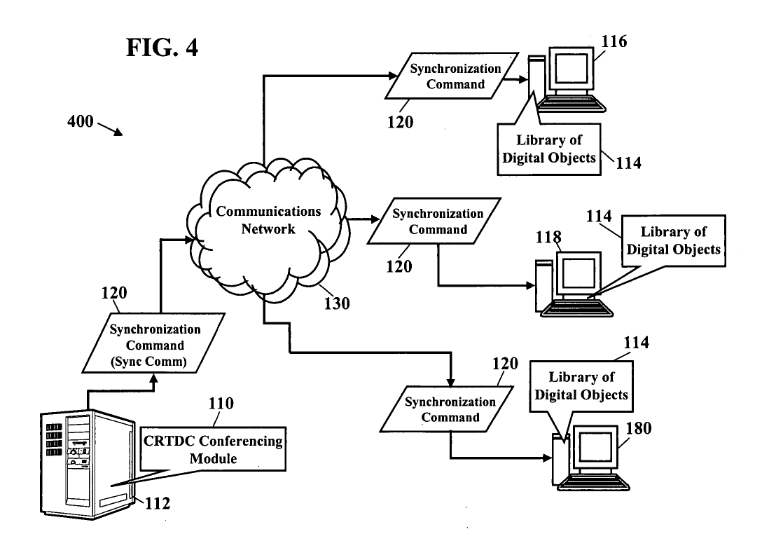

Referring now to FIG. 3, a concurrent real-time and distributed computing and/or distributed objects conferencing network 300 is further established with the add-in participant communications device 180 such that a set of communications instructions 320 may notify the add-in participant communications device 180 of a subsequent conference communications connection with the host communications device 120 and concurrently communicate the library 114 of digital objects with the communication of the real-time object 220 such that the add-in participant maintains real-time communication of current presentation materials (i.e., one or more synchronized objects 220) until the subsequent conference communications connection is set-up. As shown in FIG. 4, the subsequent conference communications connection is established between the host communications device 112 and the add-in participant communications device 180 via communications network 130. Synchronization commands 120 are then issued during the remainder of conference such that the Concurrent Real Time and Distributed Computing/Objects Conferencing Module 110 communicates subsequent synchronization commands 120 from the host computer 112 to each participant communications devices 116, 118 and to the add-in participant communications device 180. The synchronization command 120 commands/instructs the participant communications devices 116, 118 and the add-in participant communications device 180 to visually and/or audibly present the selected object from the library 24 of digital objects. That is, as the host computer 112 switches from one object to another object in the library 114 of digital objects, each synchronization command 120 instructs the participant communications devices 116, 118 and the add-in participant communications device 180 to “follow along” and synchronize with the host computer 112.

Referring now to FIG. 5, a concurrent real-time and distributed computing and/or distributed objects peer to peer (P2P) conferencing network 500 is further established with the add-in participant communications device 180 such that a set of communications instructions (similar to reference numeral 320 of FIG. 3) may notify the add-in participant communications device 180 of a subsequent conference communications connection with an upstream participant communications device 118. The host computer 112 (or, alternatively, the upstream communications device 118) concurrently communicates the library 114 of digital objects with the communication of the real-time object 220 such that the add-in participant maintains real-time communication of current presentation materials (i.e., one or more synchronized objects 0.220) until the subsequent conference communications connection is set-up. The subsequent conference communications connection is established between the upstream participant communications device 118 and the add-in participant communications device 180 when the library 114 of digital objects is stored to the add-in participant communications device 180 (or stored such that the add-in participant communications device 180 has local access to the library). The upstream participant communications device 118 communicates with the add-in participant communications device 180 similar to communications with a downstream participant communications device. That is, subsequent synchronization commands 120 are issued via peer to peer network 500. As the conference further progresses, the Concurrent Real Time and Distributed Computing/Objects Conferencing Module 110 communicates the synchronization command 120 from the server 112 to each upstream participant communications devices 116, 118, and each upstream participant communications devices 116, 118 communicates the synchronization command 120 to an associated downstream participant communications device (e.g., upstream participant communications device 118 communicates the synchronized communications 120 to add-in participant communications device 180). The synchronization command 120 commands/instructs a receiving participant communications device (1) to communicate the synchronization command 120 within the peer to peer network 500 and (2) to visually and/or audibly present the synchronized object from the library 114 of digital objects to the receiving participant communications device (e.g., reference numerals 116, 118 and 180 of FIG. 5). That is, as the server 112 switches from one synchronized object to another synchronized object in the library 114 of digital objects, each synchronization command 120 is communicated within the peer to peer network 500 to instruct the peer to peer participant communications devices 116, 118, and 180 to “follow along” and synchronize with the server 112.

Referring now to FIG. 6, a concurrent real-time and distributed computing and/or distributed objects intermediate host conferencing network 600 is further established with the add-in participant communications device 180 such that a set of communications instructions (similar to reference numeral 320 of FIG. 3) may notify the add-in participant communications device 180 of a subsequent conference communications connection with an intermediate host communications device 118. As the conference further progresses, the Concurrent Real Time and Distributed Computing/Objects Conferencing Module communicates a subsequent synchronization command 120 from the server 112 to an intermediate host communications device 118 and to participant communications device 116 (which may be established as an intermediate host or as independent participant, similar to participant communications device 116 of network 300 in FIG. 3). Then, an intermediate host-resident Intermediate Host Conferencing Module 610 receives the synchronization command 120 and instructs the intermediate host communications device 118 (1) to communicate a subsequent synchronized object 220 with presentation instructions to associated downstream add-in participant communications devices 180 and (2) to visually and/or audibly present (e.g., the presentation instructions) the subsequent synchronized object 220 from the library 114 of digital objects to the intermediate host communications device 118. Thereafter, the subsequent synchronized object 220 is visually and/or audibly presented to downstream add-in participant communications device 180. That is, for example, as the intermediate host communications device 118 switches from one synchronized object 220 to another synchronized object 220 in the library 114 of digital objects, the intermediate host participant communications devices 118 presents the synchronized object 220 and/or communicates the synchronized object 220 with presentation instructions to associated downstream add-in participant communications device 180 so that all of the add-in participant “follows along” with the intermediate host communications device 118. The intermediate host communications device 118 may switch from one synchronized object 220 to another synchronized object 220 in the library 114 when either (1) it receives the synchronization command 120 from the host server 112 or (2) the host server 112 enables a synchronization override command to the intermediate host communications device 118 such that the intermediate host communications device 118 autonomously manages communications and selection of the synchronized object 220 with the associated downstream add-in participant communications device 180 during the conference.

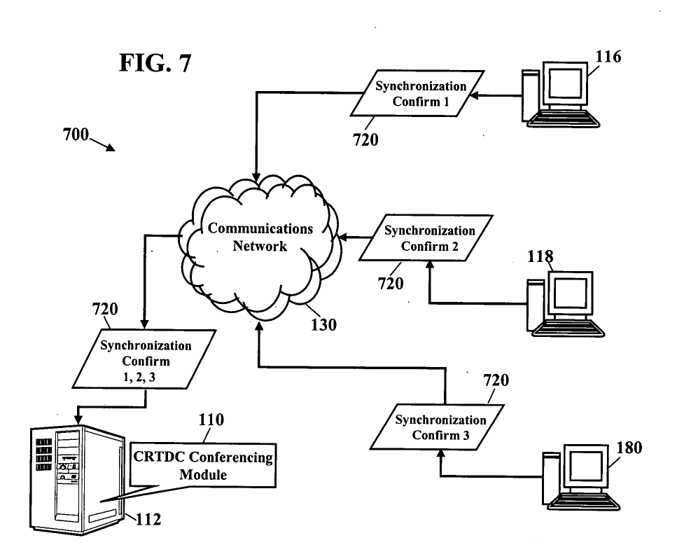

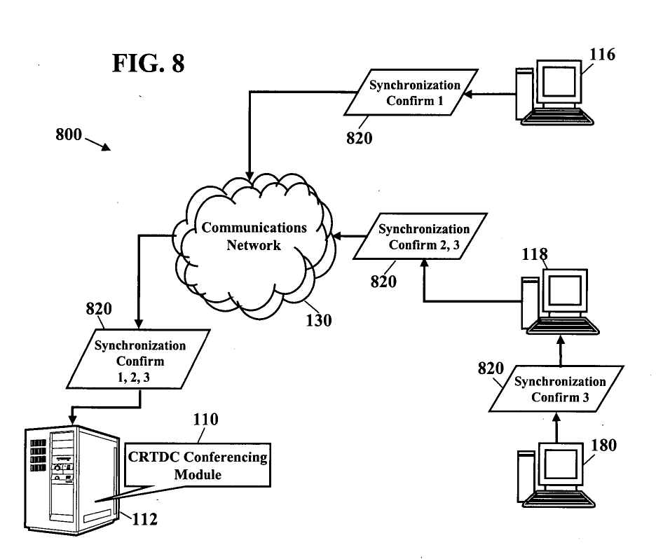

After the synchronization command (shown as reference numeral 120 in FIGS. 4-6) is communicated within the concurrent real-time and distributed computing/objects conferencing network (e.g., reference numerals 400, 500, and 600 of FIGS. 4-6), the add-in participant communications device 180 and the participant communications devices 116, 118 may also acknowledge synchronization. As shown in FIGS. 7-8, after each participant communications devices 116, 118 and the add-in participant communications device 180 successfully (or, alternatively, unsuccessfully) presents the object from the library 114, the participant communications devices 116, 118, and/or the add-in participant communications device 180 may return communicate a synchronization confirmation. FIG. 7 illustrates the communication of a synchronization confirmation 720, either within the concurrent real-time and distributed computing and/or distributed objects conferencing network (shown as reference numeral 200 in FIG. 2) or within the concurrent real-time and distributed computing and/or distributed objects conferencing network (shown as reference numeral 400 in FIG. 4). FIG. 8 illustrates the communication of a synchronization confirmation 820 either within the concurrent real-time and distributed computing and/or distributed objects peer to peer (P2P) conferencing network (shown as reference numeral 500 of FIG. 5) or within the concurrent real-time and distributed computing and/or distributed objects intermediate host conferencing network (shown as reference numeral 600 of FIG. 6). Regardless of the communications connections of the concurrent real-time and distributed computing and/or distributed objects conferencing network, the synchronization confirmation 720 or 820 communicates via the communications network 130 to the host communications device 112 and confirms the successful (or, alternatively, unsuccessful) presentation of the object on the participant communications device 116, 118 and/or on the add-in participant communications device 180.

The synchronization confirmation provides several advantages. The synchronization confirmation may help to ensure and/or to provide helpful information that all participants and the add-in participant are synchronized before the host and/or intermediate host advances to the next object in the library 114 of digital objects. For example, an intermediate host-resident Intermediate Host Conferencing Module (shown as reference numeral 610 of FIG. 6) may use the synchronization confirmation 820 to force the intermediate host communications device 118 (and, in further embodiments, also the host communications device 112) to delay communication of any subsequent synchronized objects 220. In further exemplary embodiments, the synchronization confirmation 720 or 820 may include additional information, such as a request from one (or more) of the participant communications devices 116, 118 or the add-in participant communications device. For example, the add-in participant 118 could request to exit the conference, to delay presentment of the synchronized object, to access to a non-synchronized digital object, for authority to distribute the object to a non-participant of the conference, for authority to modify the object, to terminate further communication of the synchronization confirmation, and/or other requests. In response to the synchronization confirmation, a subsequent synchronized command 120, or synchronized object 220 of the intermediate host conference network 600, may provide commands and/or instructions that enable the request of the add-in participant, such as commands and/or instructions to delay presentment of the synchronized object, to access to any object from the library of digital objects, to distribute the object to the non-participant, to modify the object, and/or to terminate further communication of the synchronized object.

According to some of the embodiments, the Concurrent Real Time and Distributed Computing/Objects Conferencing Module 110 can also ignore the synchronization confirmation 720 or 820. The synchronization confirmation 720 or 820, as explained above, provides a tool that may help ensure that participants and the add-in participant are synchronized. The Concurrent Real Time and Distributed Computing/Objects Conferencing Module 110, however, can also be configured to ignore receipt of one or more synchronization confirmations 720 or 820. That is, for example, the Concurrent Real Time and Distributed Computing/Objects Conferencing Module 110 may allow the add-in participant communications device 180 to advance to a subsequent object in the library 114 without first receiving the synchronization confirmation 720 from the add-in participant communications device 180. This feature may also allow the add-in participant to request any object in the library 114 such that they can “jump” ahead, or lag behind, and view/hear any object.

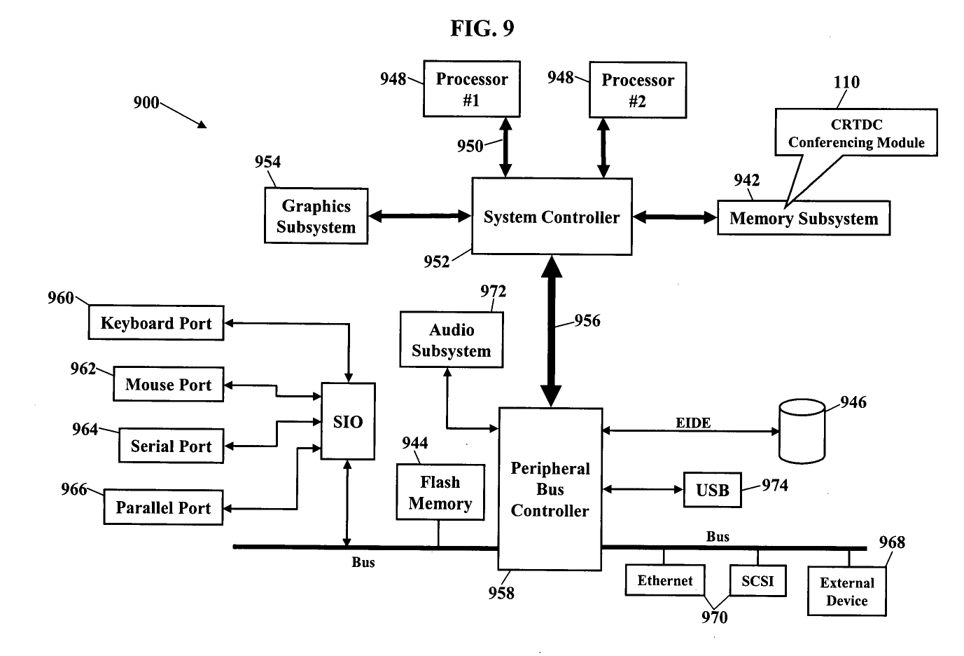

FIG. 9 illustrates a block diagram showing the Concurrent Real Time and Distributed Computing/Objects (referred to as “CRTDC” in FIG. 5) Conferencing Module 110 residing in a computer system 900. The computer system 900 may be any computing system, such as the server (shown as reference numeral 112 in FIGS. 1-8), a laptop/desktop computer, a tablet computer, and/or other computer systems including wired and wireless communications devices. As FIG. 9 shows, the Concurrent Real Time and Distributed Computing/Objects Conferencing Module 110 operates within a system memory device. The Concurrent Real Time and Distributed Computing/Objects Conferencing Module 110, for example, is shown residing in a memory subsystem 942. The Concurrent Real Time and Distributed Computing/Objects Conferencing Module 110, however, could also reside in flash memory 944 or a peripheral storage device 946. The computer system 900 also has one or more central processors 948 executing an operating system. The operating system, as is well known, has a set of instructions that control the internal functions of the computer system 900. A system bus 950 communicates signals, such as data signals, control signals, and address signals, between the central processor 948 and a system controller 952 (typically called a “Northbridge”). According to some of the embodiments of this invention, these signals include synchronization commands, synchronized objects, and/or synchronization confirmations described herein. The system controller 952 provides a bridging function between the one or more central processors 948, a graphics subsystem 954, the memory subsystem 942, and a PCI (Peripheral Controller Interface) bus 956. The PCI bus 956 is controlled by a Peripheral Bus Controller 958. The Peripheral Bus Controller 958 (typically called a “Southbridge”) is an integrated circuit that serves as an input/output hub for various peripheral ports. These peripheral ports are shown including a keyboard port 960, a mouse port 962, a serial port 964 and/or a parallel port 966 for a video display unit, one or more external device ports 968, and networking ports 970 (such as SCSI or Ethernet). The Peripheral Bus Controller 958 also includes an audio subsystem 972. Those of ordinary skill in the art understand that the program, processes, methods, and systems described in this patent are not limited to any particular computer system or computer hardware. Other architectures are possible, and the Concurrent Real Time and Distributed Computing/Objects Conferencing Module 110 can operate in any architecture.

Those of ordinary skill in the art also understand the central processor 948 is typically a microprocessor. Advanced Micro Devices, Inc., for example, manufactures a full line of ATHLON™ microprocessors (ATHLON™ is a trademark of Advanced Micro Devices, Inc., One AMD Place, P.O. Box 3453, Sunnyvale, Calif. 94088-3453, 408.732.2400, 800.538.8450, www.amd.com). The Intel Corporation also manufactures a family of X86 and P86 microprocessors (Intel Corporation, 2200 Mission College Blvd., Santa Clara, Calif. 95052-8119, 408.765.8080, www.intel.com). Other manufacturers also offer microprocessors. Such other manufacturers include Motorola, Inc. (1303 East Algonquin Road, P.O. Box A3309 Schaumburg, Ill. 60196, www.Motorola.com), International Business Machines Corp. (New Orchard Road, Armonk, N.Y. 10504, (914) 499-1900, www.ibm.com), Sun Microsystems, Inc. (4150 Network Circle, Santa Clara Calif. 95054, www.sun.com), and Transmeta Corp. (3940 Freedom Circle, Santa Clara, Calif. 95054, www.transmeta.com). Those skilled in the art further understand that the program, processes, methods, and systems described in this patent are not limited to any particular manufacturer's central processor.

The preferred operating system is the UNIX® operating system (UNIX® is a registered trademark of the Open Source Group, www.opensource.org). Other UNIX-based operating systems, however, are also suitable, such as LINUX® or a RED HAT® LINUX-based system (LINUX® is a registered trademark of Linus Torvalds, and RED HAT® is a registered trademark of Red Hat, Inc., Research Triangle Park, North Carolina, 1-888-733-4281, www.redhat.com). Other operating systems, however, are also suitable. Such other operating systems would include a WINDOWS-based operating system (WINDOWS® is a registered trademark of Microsoft Corporation, One Microsoft Way, Redmond Wash. 98052-6399, 425.882.8080, www.Microsoft.com). and Mac® OS (Mac® is a registered trademark of Apple Computer, Inc., 1 Infinite Loop, Cupertino, Calif. 95014, 408.996.1010, www.apple.com). Those of ordinary skill in the art again understand that the program, processes, methods, and systems described in this patent are not limited to any particular operating system.

The system memory device (shown as memory subsystem 942, flash memory 944, or peripheral storage device 946) may also contain an application program. The application program cooperates with the operating system and with a video display unit (via the serial port 964 and/or the parallel port 966) to provide a Graphical User Interface (GUI). The Graphical User Interface typically includes a combination of signals communicated along the keyboard port 960 and the mouse port 962. The Graphical User Interface provides a convenient visual and/or audible interface of the Concurrent Real Time and Distributed Computing/Objects Conferencing Module 110 with a user of the computer system 900.

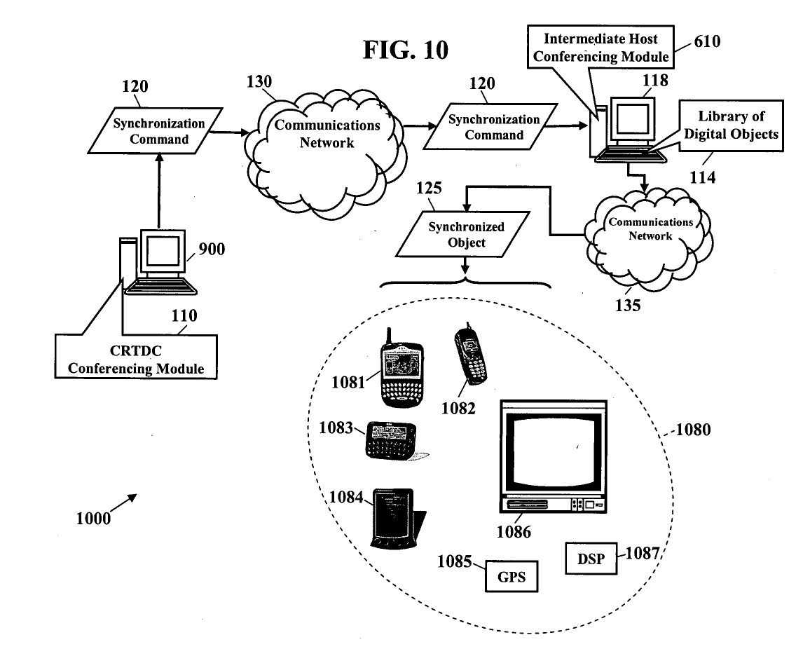

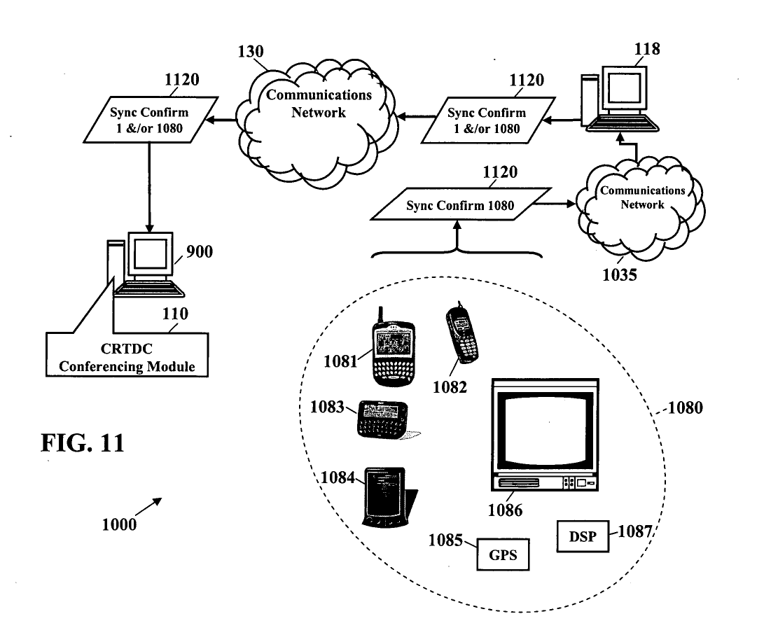

FIGS. 10 and 11 illustrate a concurrent real-time and distributed computing/objects intermediate host conferencing network 1000 according to other exemplary embodiments of this invention. The network 1000 includes the personal computer 900 hosting the conference over communications network 130 with an intermediate participant communications device 118 having an established subsequent communications connection with an alternative add-in participant communications device 1080. FIGS. 10 and 11 illustrate one or more alternate add-in participant communications devices 1180 that may include an Internet Protocol (IP) phone 1081, a cellular/satellite phone 1082, a pager 1083, a personal digital assistant (PDA) 1084, a Global Positioning System (GPS) device 1085, an interactive television 1086, or any computer and/or communications device utilizing the digital signal processor (DSP) 1087. The alternate add-in participant communications device 1080 may also include addressable watches, radios, vehicle electronics, clocks, printers, gateways, and other apparatuses and systems. The intermediate host communications device 118 communicates with alternate downstream participant communications device 1080 via the communications network 1035. The communications network 1035 may include a telecommunications network (e.g., Public Switched Telephone Network (PSTN), Mobile Switching Telephone Office (MSTO), and others), a data network (e.g., an Internet (sometimes alternatively known as the “World Wide Web”), an intranet, a local-area network (LAN), and/or a wide-area network (WAN)), and/or a satellite network that establishes the communications path(s) among the participants.

FIGS. 10 and 11 further illustrate the communications paths of a synchronization command 120 from the personal computer 900 to intermediate host communications device 118 and then from the intermediate host communications device 118 to the alternate add-in participant communications device 1080. The intermediate host-resident Intermediate Host Conferencing Module 610 receives the synchronization command 120, instructs the intermediate host communications device 118 to present a synchronized object 220 and to communicate the synchronized object 220 with presentation instructions to downstream participant communications device 1080, and communicates a synchronization confirmation 1120 within the concurrent real-time and distributed computing/objects intermediate host conferencing network 1000 to acknowledge a successful presentation of the synchronized object.

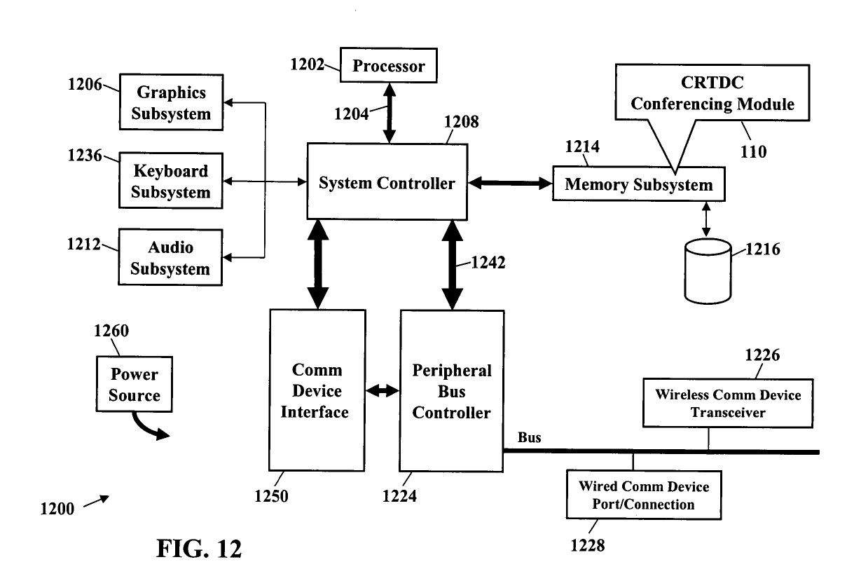

FIG. 12 illustrates another block diagram showing the Concurrent Real Time and Distributed Computing/Objects Conferencing Module 110 residing in an alternate voice/data communications device 1200. As FIG. 12 shows, the Concurrent Real Time and Distributed Computing/Objects Conferencing Module 110 operating within a system memory device. The Concurrent Real Time and Distributed Computing/Objects Conferencing Module 110, for example, is shown residing in a memory subsystem 1214. The Concurrent Real Time and Distributed Computing/Objects Conferencing Module 110, however, could also reside in flash memory 1226 or a peripheral storage device 1216. The voice/data communications device 1200 also has one or more central processors 1202 executing an operating system. The operating system, as is well known in the art, has a set of instructions that control the internal functions of the voice/data communications device 1200. A communications interface 1204 communicates signals, such as data signals, control signals, and address signals, between the central processor 1202 and a system controller 1208 (typically called a “Northbridge”). According to some of the embodiments of this invention, these signals include synchronization commands, synchronized objects, and synchronization confirmations as described herein. Additionally, the communications interface 1204 has a means to communicate a communications signal between the voice/data communications device 1200 and a communications network.

The system controller 1208 provides a bridging function between the one or more central processors 1202, a graphics subsystem 1206, a keyboard subsystem 1236, an audio subsystem 1212, the memory subsystem 1214, a PCI (Peripheral Controller Interface) bus 1242, and a Communications (“Comm”) Device Interface 1250. The PCI bus 1242 is controlled by a Peripheral Bus Controller 1224. The Peripheral Bus Controller 1224 (typically called a “Southbridge”) is an integrated circuit that serves as an input/output hub for various peripheral ports and/or transceivers. These peripheral ports allow the voice/data communications device 1200 to communicate with a variety of devices through networking ports (such as SCSI or Ethernet) and/or transceivers that include Wireless Communications (“Comm”) Device Transceiver 1226 (for communication of any frequency signal in the electromagnetic spectrum, such as, for example, Wireless 802.11 and Infrared) and Wired Communications (“Comm”) Device Port/Connection 1228 (such as modem V90+ and compact flash slots). These peripheral ports could also include other networking ports, such as, a serial port (not shown) and/or a parallel port (not shown). The Communications device Interface 1250 allows the voice/data communications device 1200 to monitor, detect, receive, and decode incoming (and outgoing) communications signals to the communications device(s) connected to the Wireless Communications device Transceiver 1226 and/or the Wired Communications device Port/Connection 1228. Further, the Communications device Interface 1250 may transmit the communications signal to the Wireless Communications device Transceiver 1226 and/or the Wired Communications device Port/Connection 1228. Still further, the voice/data communications device 1200 may include a power source 1260, such as a rechargeable battery to provide power and allow the voice/data communications device 1200 to be portable. Additionally, those of ordinary skill in the art understand that the program, processes, methods, and systems described in this patent are not limited to any particular computer system or computer hardware.

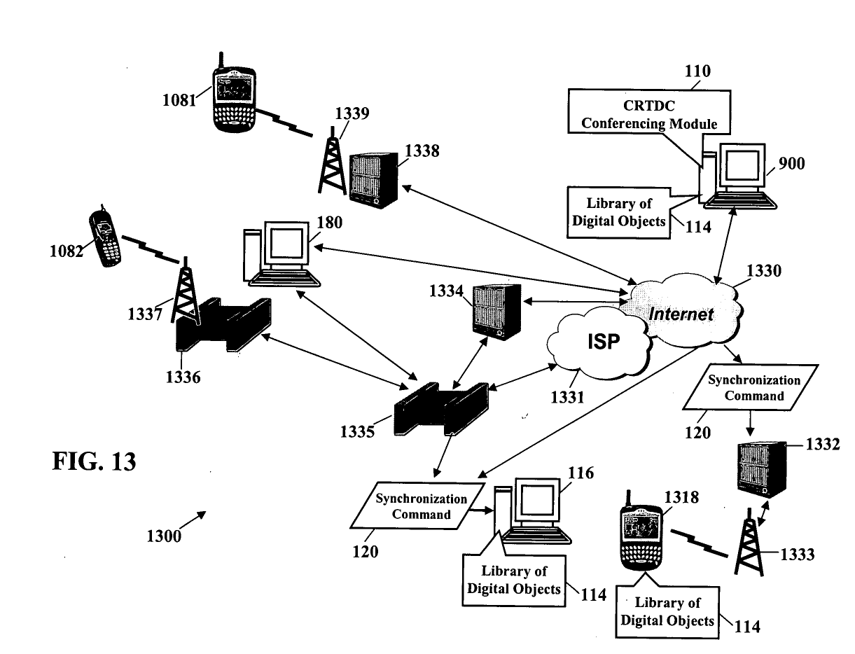

FIG. 13 illustrates a concurrent real-time and distributed computing/objects conferencing network 1300 that includes host computer system 900, participant communications device 116, alternate participant communications device 1318 (shown as a Voice over Internet Protocol (VoIP) phone), add-in participant communications device 180, alternate add-in communications devices 1081 and 1082 (shown respectively as another VoIP phone and as a cellular phone), and a communications network that includes a data network shown as Internet 1330, an Internet Service Provider (ISP) 1331, a wireless data gateway 1332, a wireless data gateway antenna 1333, a VoiceXML gateway 1334, a mobile switching telephone office 1336, a mobile communications antenna 1337, another wireless data gateway 1338, and another wireless data gateway antenna 1339. As shown in FIG. 13, an ongoing conference is established between the host computer system 900 and the participant communications device 116 and 1318. The non-participants 180, 1081, and 1082 communicate with the host computer system 900 to join the on-going conference, and the host computer system communicates a real-time object of the conference to each of the add-in participant communications devices 180, 1081, and 1082. Thereafter, the host computer system 900 analyzes communications factors to determine subsequent communications connections for each of the add-in participants 180, 1081, and 1082. For example, the host computer system 900 may identify participant communications device 1318 as a VoIP communications device with signaling via the Internet 1330, the wireless data gateway 1332, and antenna 1333 to determine whether the add-in participant communications device 1081, another VoIP phone, may access signaling with the wireless data gateway 1332 and antenna 1333 if the two communications devices are in a similar geographic area.

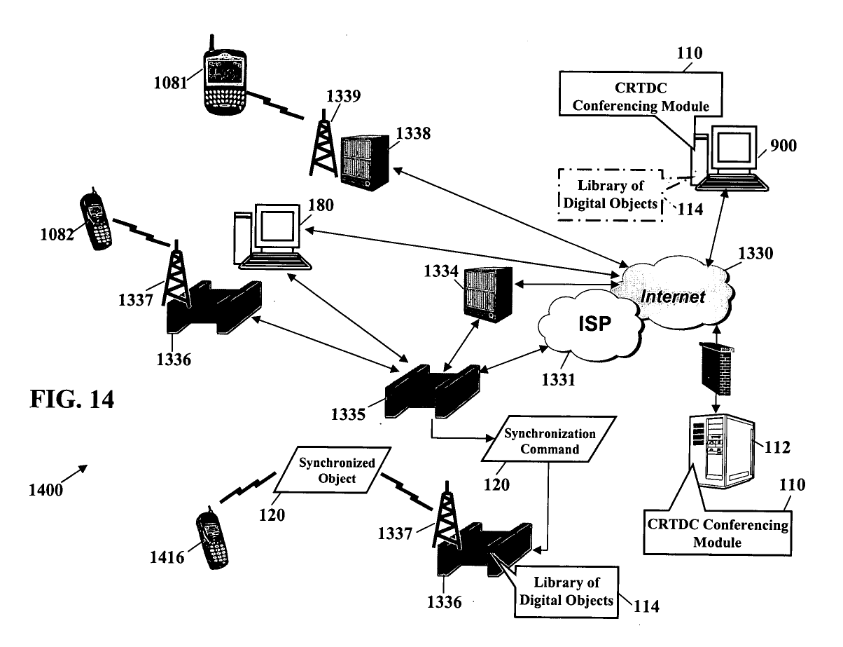

FIG. 14 illustrates a concurrent real-time and distributed computing/objects mobile conferencing network 1300 that includes host computer system 900, server 112, mobile participant communications device 1416, alternate add-in participant communications devices 1081 and 1082 (shown respectively as another VoIP phone and as a cellular phone), and a communications network that includes a data network shown as Internet 1330, an Internet Service Provider (ISP) 1331, a wireless data gateway 1338, a wireless data gateway antenna 1339, a VoiceXML gateway 1334, a mobile switching telephone office 1336, a mobile communications antenna 1337, another mobile switching telephone office 1436, and another mobile communications antenna. As shown in FIG. 14, an ongoing conference is established between the server 112 and the mobile participant communications device 1416. Then, the non-participants 1081, and 1082 communicate with the host computer system 900 (or, alternatively, with the server 112) to join the on-going conference. In response, the host computer system 900 communicates a real-time object of the conference to each of the add-in participant communications devices 1081, and 1082. Thereafter, the host computer system 900 analyzes communications factors to determine subsequent communications connections for each of the add-in participants 1081, and 1082 and establishes the subsequent communications connection. For example, the host computer system 900 may identify add-in participant communications device 1082 as a cellular communications device with signaling via MSTO 1336, antenna 1337, CO/router/softswitch 1335, ISP 1331 and/or VoiceXML 1334, and the Internet 1330 and analyze whether the add-in participant communications device 1082, another cellular phone, may access signaling with the MSTO 1436 and antenna 1437 of mobile participant communications device 1416 (if the two communications devices are in a geographic cell sharing the antenna 1437 and/or MSTO 1436).

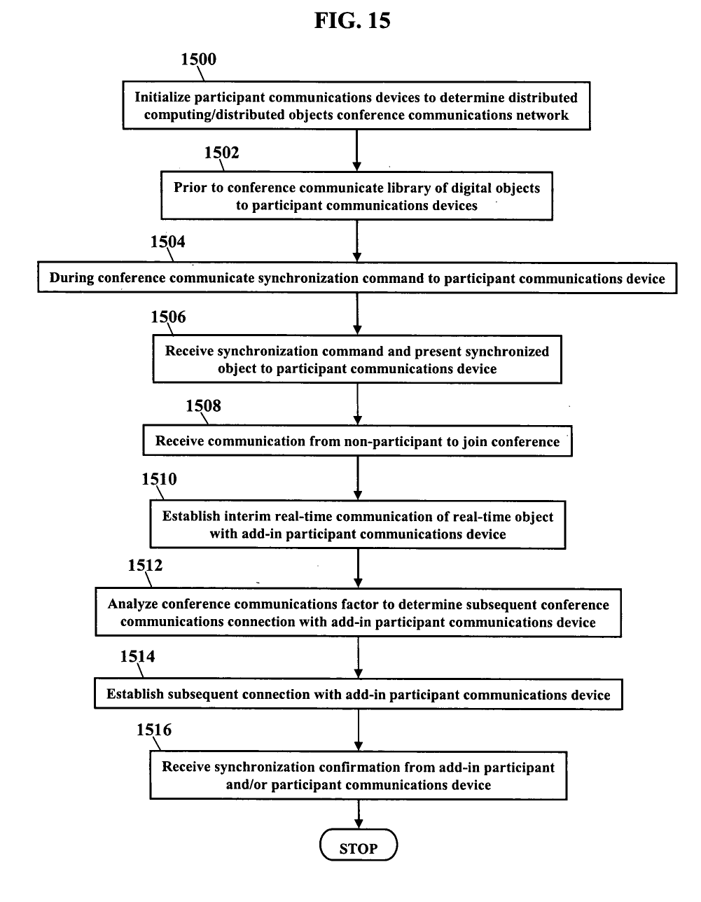

FIG. 15 is a flowchart illustrating an exemplary method of conducting a conference among participants and an add-in participant. Prior to the conference, a list of participant communications devices is initialized to determine a distributed computing and/or distributed objects conference communications network (Block 1500), and then, a library of digital objects (and any other necessary information, such as an Intermediate Host Conferencing Module 610) are communicated to the participant communications devices (Block 1502). Then, during the conference, a synchronization command is communicated from a host communications device to the participant communications device (Block 1504). The participant communications devices receives the synchronization command and/or the synchronized object and are instructed to present the synchronized object (Block 1506). Thereafter, a non-participant communicates with the host (or a selected participant communications device) to join the conference (Block 1508). In response, the host establishes an interim real-time communication of the real-time object and streams the communication to the add-in participant (Block 1510). The real-time object is the synchronized object being viewed by the participants of the ongoing conference. The host also analyzes a conference communications factor to establish a subsequent conference communications connection with the add-in participant (Block 1512). The subsequent conference communications connection is established with the add-in participant and the interim real-time communications connection may be terminated (Block 1514). After the synchronized object is presented to the participant and the add-in participant communications devices, a synchronization confirmation is then received to acknowledge a successful (or, alternatively, unsuccessful) presentation of the synchronized object within the concurrent real-time and distributed computing/objects conferencing network as described in further detail in some of the above embodiments (Block 1516).

The Concurrent Real Time and Distributed Computing/Objects Conferencing Module may be physically embodied on or in a computer-readable medium. This computer-readable medium may include CD-ROM, DVD, tape, cassette, floppy disk, memory card, and large-capacity disk (such as IOMEGA®, ZIP®, JAZZ®, and other large-capacity memory products (IOMEGA®, ZIP®, and JAZZ® are registered trademarks of Iomega Corporation, 1821 W. lomega Way, Roy, Utah 84067, 801.332.1000, www.iomega.com). This computer-readable medium, or media, could be distributed to end-users, licensees, and assignees. These types of computer-readable media, and other types not mention here but considered within the scope of the present invention, allow the Concurrent Real Time and Distributed Computing/Objects Conferencing Module to be easily disseminated. A computer program product for conducting a conference amongst intermediate host participants includes the Concurrent Real Time and Distributed Computing/Objects Conferencing Module stored on the computer-readable medium. According to some of the embodiments of this invention, the Concurrent Real Time and Distributed Computing/Objects Conferencing Module may be stored in a memory device of a host communications device and/or a server having the presentation materials. Alternatively, the Concurrent Real Time and Distributed Computing/Objects Conferencing Module may be stored in a selected participant communications device, such as an intermediate host communications device. Prior to the conference, the Concurrent Real Time and Distributed Computing/Objects Conferencing Module initializes the conference for at least one participant communications device and communicates a library of digital objects to the participant communications device. During the conference, the Concurrent Real Time and Distributed Computing/Objects Conferencing Module communicates a synchronization command to the participant communications device, and in response to the synchronization command, the participant communications device presents an object from the library of digital objects, such that the participant communications device “follows along” with the synchronized object selected by the host communications device. Then, during the conference, the Concurrent Real Time and Distributed Computing/Objects Conferencing Module receives an add-in communication from a non-participant communications device to add in to the conference. In response to this communication, the Concurrent Real Time and Distributed Computing/Objects Conferencing Module communicates a real-time object with presentation instructions to the add-in participant communications device such that the add-in participant has near real-time access to the synchronized object of the ongoing presentation. The real-time object is communicated to the add-in participant communications device via a communications network, such as, for example, a telecommunications network (e.g., Public Switched Telephone Network (PSTN)), a data communications network (e.g., an Internet Protocol (IP) communications network), and/or a satellite network. Further, the Concurrent Real Time and Distributed Computing/Objects Conferencing Module analyzes a conference communications factor between the participant communications device and the add-in participant communications device and between the host communications device and each of the participant communications device and of the add-in participant communications device to determine a subsequent conference communications connection with the add-in participant communications device. For example, the Concurrent Real Time and Distributed Computing/Objects Conferencing Module may compare transmission rates between the host communications device and the add-in participant communications device with transmission rates between the participant communications device and the add-in participant communications device to determine which communications connections to the add-in participant communications device is quicker, and thereby, select the quicker communications connection for subsequent conference communications with the add-in participant communications device. After the subsequent conference communications connection is selected, then the Concurrent Real Time and Distributed Computing/Objects Conferencing Module establishes the subsequent conference communications connection with the add-in participant communications device. After the synchronized object is presented to the add-in participant communications device and/or the participant communications device, a synchronization acknowledgment is communicated via the communications network to the host, and the synchronization acknowledgment confirms a successful (or, alternatively, unsuccessful) presentation of the object on the participant communications devices and/or the add-in participant communications device.

The Concurrent Real Time and Distributed Computing/Objects Conferencing Module may also be physically embodied on or in any addressable (e.g., HTTP, I.E.E.E. 802.11, Wireless Application Protocol (WAP)) wireline and/or wireless communications device capable of presenting an IP address. Examples could include a computer, a wireless personal digital assistant (PDA), an Internet Protocol mobile phone, or a wireless pager.

While this invention has been described with respect to various features, aspects, and embodiments, those skilled and unskilled in the art will recognize the invention is not so limited. Other variations, modifications, and alternative embodiments may be made without departing from the spirit and scope of this invention.

1. A method of conducting a conference, comprising the steps of:
initializing the conference amongst at least one participant communications device;
prior to the conference, communicating a library of digital objects to the participant communications device,
during the conference,
communicating a synchronization command from the host communications device to the participant communications device, wherein in response to the synchronization command, the participant communications device presents an object from the library of digital objects,
receiving an add-in communication from a non-participant communications device to add in to the conference,
in response to the add-in communication, communicating a real-time object with presentation instructions from the host communications device to the add-in participant communications device,
analyzing a conference communications factor between at least one participant communications device and the add-in participant communications device and between the host communications device and the at least one participant communications device and of the add-in participant communications device to determine a subsequent conference communications connection with the add-in participant communications device, and
establishing the subsequent conference communications connection with the add-in participant communications device.

2. The method of claim 1, wherein the step of establishing the subsequent conference communications connection with the add-in participant communications device comprises:
if the conference communications connection requires a distributed communications connection with the host, then:
communicating the library of digital objects from the host communications device to the add-in participant communications device, and
communicating the synchronization command and a termination command from the host communications device to the add-in participant communications device, the synchronization command instructing the add-in participant communications device to present the object from the library of digital objects, and the termination command instructing the add-in participant communications device that communication of the real-time object from the host communications device is terminated.

3. The method of claim 1, wherein the step of establishing the subsequent conference communications connection with the add-in participant communications device comprises:
if the conference communications connection requires a communications connection with an upstream participant communications device, then:
communicating an add-in participant command with communications instructions from the host communications device to the upstream participant communications device,
communicating the library of digital objects from the upstream participant communications device from the upstream participant communications device to the add-in participant communications device, and
communicating the synchronization command and the termination command from the upstream participant communications device to the add-in participant communications device, the synchronization command instructing the add-in participant communications device to present the object from the library of digital objects, and the termination command instructing the add-in participant communications device that communication of the real-time object from the host communications device is terminated.

4. The method of claim 1, wherein the step of establishing the subsequent conference communications connection with the add-in participant communications device comprises:
if the conference communications connection requires a communications connection with an intermediate host participant communications device, then:
communicating an add-in participant command with communications instructions from the host communications device to the intermediate host participant communications device,
communicating the object with presentation instructions from the intermediate host participant communications device to the add-in participant communications device, wherein in response to the synchronization command, the add-in participant communications device presents a subsequent object from the library of digital objects, and
communicating the termination command from the intermediate host participant communications device to the add-in participant communications device, the termination command instructing the add-in participant communications device that communication of the real-time object from the host communications device is terminated.

5. The method of claim 1, wherein the step of establishing the subsequent conference communications connection with the add-in participant communications device comprises:
if the conference communications connection maintains the real-time communications connections, then communicating a subsequent real-time object with presentation instructions from the host communications device to the add-in participant communications device.

6. The method of claim 1, further comprising:
communicating a conference management command via the conference communications connection to the add-in participant communications device, wherein the conference management command comprises at least one of (i) a command to exit the conference, (ii) a command to delay presentment of the conference, (iii) a synchronization override command to access to any object from the library of digital objects, (iv) authority to distribute the object to a non-participant, (v) authority to modify the object, (vi) a command to terminate further communication of the synchronization acknowledgement, and (vii) a command to modify a communication connection of the conference.

7. The method of claim 1, further comprising the step of:
receiving a synchronization acknowledgment identifying at least one participant communications device and the add-in participant communications device, the synchronization acknowledgement further confirming a successful presentation of the object to the at least one participant communications device and the add-in participant communications device.

8. The method of claim 7, further comprising the step of delaying communication of a subsequent synchronization command until the host communications device receives the synchronization acknowledgment.

9. The method of claim 7, wherein the synchronization acknowledgment further provides at least one of (i) a request to exit the conference, (ii) a request to delay presentment of the conference, (iii) a request to access to a non-synchronized digital object, (iv) a request for authority to distribute the object to a non-participant of the conference, (v) a request for authority to modify the object, and (vi) a request to terminate further communication of the synchronization acknowledgement.

10. The method of claim 7, further comprising the step of:
ignoring receipt of the synchronization acknowledgment from the add-in participant communications device, thus allowing the add-in participant communications device to request any object from the library of digital objects.

11. The method of claim 1, wherein the step of analyzing the conference communications factor between at least one participant communications device and the add-in participant communications device and between the host communications device and the at least one participant communications device and of the add-in participant communications device to determine the subsequent conference communications connection with the add-in participant communications device comprises analyzing the conference communications factor comprising at least one of transmission rates of a communications connection, cost of a communications connection, security of a communications connection, reliability of a communications connection, reconfiguration of an existing conference network communications connection with the participant communications device, and access to a communications connection.

12. A system, comprising:
a Concurrent Real Time and Distributed Computing/Objects Conferencing Module stored in a memory device, and a processor communicating with the memory device,
the Concurrent Real Time and Distributed Computing/Objects Conferencing Module initializing the conference amongst at least one participant communications device, communicating a library of digital objects to the participant communications device prior to the conference, and during the conference, communicating a synchronization command from a host communications device to the participant communications device, wherein in response to the synchronization command, the participant communications device presents an object from the library of digital objects, receiving an add-in communication from a non-participant communications device to add in to the conference, and in response to the add-in communication, communicating a real-time object with presentation instructions from the host communications device to the add-in participant communications device, further analyzing a conference communications factor between at least one participant communications device and the add-in participant communications device and between the host communications device and the at least one participant communications device and of the add-in participant communications device to determine a subsequent conference communications connection with the add-in participant communications device, and establishing the subsequent conference communications connection with the add-in participant communications device.

13. The system of claim 12, wherein the step of establishing the subsequent conference communications connection with the add-in participant communications device comprises:
if the conference communications connection requires a distributed communications connection with the host, then the Concurrent Real Time and Distributed Computing/Objects Conferencing Module:
communicating the library of digital objects from the host communications device to the add-in participant communications device, and
communicating the synchronization command and a termination command from the host communications device to the add-in participant communications device, the synchronization command instructing the add-in participant communications device to present the object from the library of digital objects, and the termination command instructing the add-in participant communications device that communication of the real-time object from the host communications device is terminated.

14. The system of claim 12, wherein the step of establishing the subsequent conference communications connection with the add-in participant communications device comprises:
if the conference communications connection requires a communications connection with an upstream participant communications device, then the Concurrent Real Time and Distributed Computing/Objects Conferencing Module:
communicating an add-in participant command with communications instructions from the host communications device to the upstream participant communications device,
communicating the library of digital objects from the upstream participant communications device from the upstream participant communications device to the add-in participant communications device, and
communicating the synchronization command and the termination command from the upstream participant communications device to the add-in participant communications device, the synchronization command instructing the add-in participant communications device to present the object from the library of digital objects, and the termination command instructing the add-in participant communications device that communication of the real-time object from the host communications device is terminated.

15. The system of claim 12, wherein the step of establishing the subsequent conference communications connection with the add-in participant communications device comprises:
if the conference communications connection requires a communications connection with an intermediate host participant communications device, then the Concurrent Real Time and Distributed Computing/Objects Conferencing Module:
communicating an add-in participant command with communications instructions from the host communications device to the intermediate host participant communications device,
communicating the object with presentation instructions from the intermediate host participant communications device to the add-in participant communications device, wherein in response to the synchronization command, the add-in participant communications device presents a subsequent object from the library of digital objects, and
communicating the termination command from the intermediate host participant communications device to the add-in participant communications device, the termination command instructing the add-in participant communications device that communication of the real-time object from the host communications device is terminated.

16. The system of claim 12, wherein the step of establishing the subsequent conference communications connection with the add-in participant communications device comprises:
if the conference communications connection maintains the real-time communications connections, then the Concurrent Real Time and Distributed Computing/Objects Conferencing Module communicating a subsequent real-time object with presentation instructions from the host communications device to the add-in participant communications device.

17. The system of claim 12, the Concurrent Real Time and Distributed Computing/Objects Conferencing Module further communicating a conference management command via the conference communications connection to the add-in participant communications device, wherein the conference management command comprises at least one of (i) a command to exit the conference, (ii) a command to delay presentment of the conference, (iii) a synchronization override command to access to any object from the library of digital objects, (iv) authority to distribute the object to a non-participant, (v) authority to modify the object, (vi) a command to terminate further communication of the synchronization acknowledgement, and (vii) a command to modify a communication connection of the conference.

18. The system of claim 12, the Concurrent Real Time and Distributed Computing/Objects Conferencing Module further receiving a synchronization acknowledgment identifying at least one participant communications device and the add-in participant communications device, the synchronization acknowledgement further confirming a successful presentation of the object to at least one of the participant communications device and the add-in participant communications device.

19. The system of claim 18, the Concurrent Real Time and Distributed Computing/Objects Conferencing Module delaying communication of a subsequent synchronization command until the host communications device receives the synchronization acknowledgment.

20. The system of claim 12, the add-in participant communications device comprising at least one of a computer, a voice-over internet protocol phone, a digital music device, a digital recording device, a personal digital assistant, an interactive television, a global positioning system, and a digital signal processor.

21. A computer program product, comprising:
a computer-readable medium; and
a Concurrent Real Time and Distributed Computing/Objects Conferencing Module stored on the computer-readable medium, the Concurrent Real Time and Distributed Computing/Objects Conferencing Module initializing the conference amongst at least one participant communications device, communicating a library of digital objects to the participant communications device prior to the conference, and during the conference, communicating a synchronization command from a host communications device to the participant communications device, wherein in response to the synchronization command, the participant communications device presents an object from the library of digital objects, receiving an add-in communication from a non-participant communications device to add in to the conference, and in response to the add-in communication, communicating a real-time object with presentation instructions from the host communications device to the add-in participant communications device, further analyzing a conference communications factor between at least one participant communications device and the add-in participant communications device and between the host communications device and the at least one participant communications device and of the add-in participant communications device to determine a subsequent conference communications connection with the add-in participant communications device, and establishing the subsequent conference communications connection with the add-in participant communications device.
